(19) United States
(12) Patent Application Publication
(10) Pub. No.: US 2013/0290835 A1
(43) Pub. Date: Oct. 31, 2013

(54) Method and Apparatus for the Selection and Reformat of Portions of a Document

(71) Applicant: James Paul Hudetz, Aurora, IL (US)

(72) Inventor: James Paul Hudetz, Aurora, IL (US)

(21) Appl. No.: 13/460,241

(22) Filed: Apr. 30, 2012

(51) Int. Cl. G06F 17/24

(52) U.S. Cl. 715/249

(57) ABSTRACT

Methods, apparatus, and computer-readable medium are provided for the reformatting of documents or portions of documents. In one example, a method for reformatting a base document includes identifying a candidate for reformatting based on candidate identification criteria and displaying a plurality of portions of the base document wherein a candidate is highlighted to provide a selected candidate. The method further includes receiving format selection data indicating a selection of a model portion from among the plurality of portions and generating a reformatted portion based on model format data of the model portion and candidate content data of the selected candidate.

### CROSS-REFERENCE TO RELATED APPLICATIONS

This application is related to co-pending utility application entitled METHOD FOR CORRECTING DOCUMENT FORMATTING BASED ON SOURCE DOCUMENT and filed on even date herewith and having attorney docket number 43960.00.0007.

### BACKGROUND

The creation of documents is a task pervasive in many industries and businesses. The formatting of documents is a critical component of document creation that can significantly influence the readability, interpretation and communication of ideas and knowledge. The format of documents can be particularly important in fields such as the legal industry and communication with regulatory bodies that require particular document formats in communications with the regulatory body. With this in mind, tools have been created to assist in the creation and the formatting of documents.

Some examples of tools that exist to aid in the creation and formatting of documents include word processing applications such as Microsoft Word® and WordPerfect®. Additionally, templates and standardized forms also exist that can assist a user in the creation or formatting of documents. Many of these tools, however, require the intervention of administrators or other experts or require specialized knowledge to implement the advantages of the document creation aids.

A specific example of a document creation aid is the so-called Styles functionality of Microsoft Word®. The Styles functionality allows different formatting to be created and then applied to portions of a document. Microsoft Word® includes some standard styles that can be applied to documents. Additionally, customized styles can be created according to the particular needs of an individual or organization. These styles can then be applied to a document to aid in the formatting of the document. The Styles functionality, however, requires specialized knowledge to create and apply its functionality. As such, the Styles functionality is often under-utilized by individuals or is misunderstood.

Document formatting is also important in the context of formatting a document received from a third-party. As is often the case, a document is received from a third-party and needs to be reformatted either to revise the document to improve readability, to correct errors or inconsistencies, or to adhere to document formatting requirements. In this context, the document may contain any number of errors or include data, metadata, or formatting that makes the reformatting of the document difficult or at least frustrating to a non-expert individual.

Still further, other situations arise in which an organization or an individual may have access to templates or standard forms but these options are unsatisfactory. The individual may have needs or preferences that are different from the templates or standard forms provided by an organization. Often, however, the individual does not possess the expertise to create a new template or standardized form for his or her individual needs or preferences.

In these and other situations, individuals and organizations are faced with circumstances in which the identification of errors or inconsistent formatting is difficult given individual levels of training and expertise with existing document creation aids. Once the errors or inconsistent portions of a document are identified, a user must then go about making the changes to correct or reformat these portions of the document. Making this process even more difficult is the circumstance wherein certain portions of a document are desired to be inconsistent or that may appear to have an error but in fact do not. Given these situations and difficulties in the creation and reformatting of documents, improved tools that can identify portions of a document that may need reformatting and improved tools that provide advantageous user interfaces are needed.

### SUMMARY

The present disclosure describes methods and apparatus for the reformatting of documents or portions of documents. In one example, a method for reformatting a base document includes identifying a candidate for reformatting based on candidate identification criteria and displaying a plurality of portions of the base document wherein a candidate is highlighted to provide a selected candidate. The method further includes receiving format selection data indicating a selection of a model portion from among the plurality of portions and generating a reformatted portion based on model format data of the model portion and candidate content data of the selected candidate.

In another example, a method for facilitating the reformatting of portions of a base document includes identifying at least one candidate for reformatting based on candidate identification criteria and generating a format modification interface. The format modification interface includes a list displaying a plurality of portions of the base document, a candidate identification control that controls which candidate is highlighted to provide a selected candidate, and a model portion selection control that identifies a model portion from among the plurality of portions. The method also includes generating a reformatted portion based on model format data of the model portion and candidate content data of the selected candidate.

In another example, the model portion selection control further identifies a portion in an instance of the base document that corresponds to the model portion.

In another example, the model portion selection control is operable to restore original formatting of the reformatted portion.

### DESCRIPTION OF THE DRAWINGS

The disclosure will be more readily understood in view of the following description when accompanied by the below figures and wherein like reference numeral represent like elements, wherein:

FIG. 1 is a block diagram generally depicting one example of a formatting system in accordance with the present disclosure.

FIG. 2 is a flowchart generally depicting one example of a method for reformatting a document in accordance with the present disclosure

FIGS. 3-7 are representations of various examples of interfaces in accordance with the present disclosure.

### DETAILED DESCRIPTION

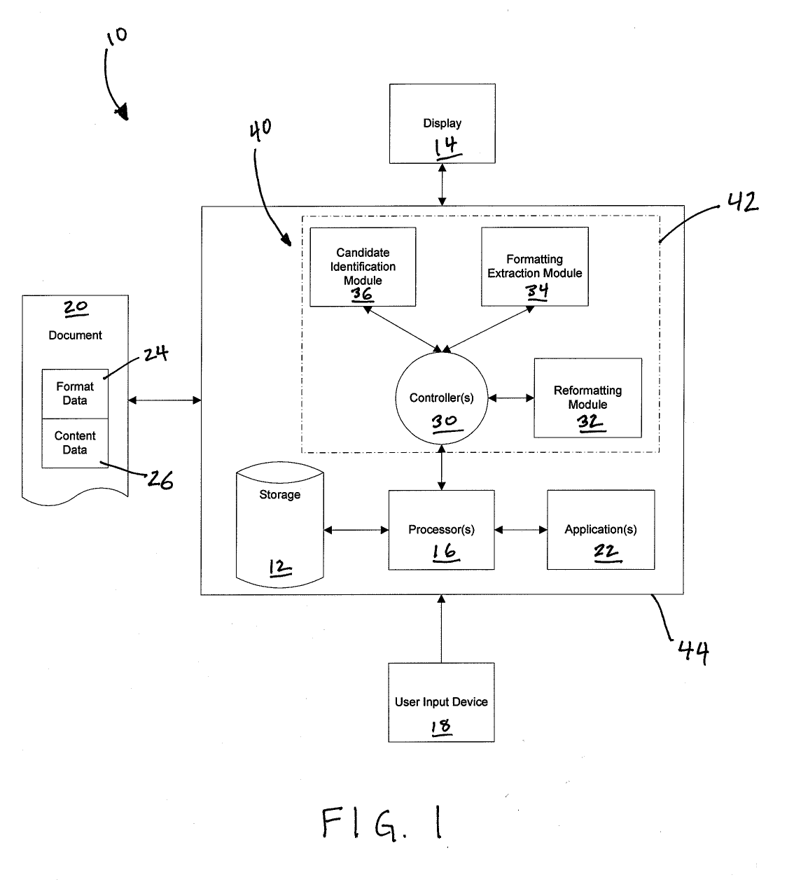

The following description of the embodiments is exemplary in nature and is in no way intended to limit the disclosure, the application of the disclosure, or uses of the subject matter contained in the disclosure. FIG. 1 illustrates a formatting system in accordance with the present disclosure. Formatting system 10, in one example, generally includes memory 42, storage 12, a processor or processors 16, a display 14, and a user input device 18. Formatting system 10 interacts with document 20. Those having skill in the art will appreciate that other components, not illustrated in FIG. 1 for ease of presentation, may be included in the formatting system 10.

As used herein, a document, such as document 20, is any electronic file containing formatted content. One example of a document is an electronic file created in a word processing application such as Microsoft Word®. Other examples of documents include, but are not limited to, spreadsheets, presentations, forms, databases, webpages, and the like. As depicted in FIG. 1, document 20 may contain content data 26 and format data 24. Content data 26 includes information regarding the text or body of document that may include the words, language, images, or other content that a user may want to include or otherwise display via the document. Format data 24 includes other information relating to how the content data 26 will be depicted in the document. Format data 24 may include information relating to the positioning of words or images, such as justification or margins, the appearance of content, such as font or typeface, and the organization or presentation of content such as bulleting, or outlining of the content. As known in the art, the format data 24 may be represented using any of a variety of markup languages, such as Extensible Markup Language (XML). These descriptions of content data 26 and format data 24 are informational only. Content data and format data may additionally include information regarding the document as is known to one of ordinary skill in the art.

Referring back to FIG. 1, one example of a formatting system 10 of the present disclosure includes computing system 44 which may be used to implement formatting tool 40. Computing system 44 includes storage 12, processor 16, application 22, and memory 42. Processor 16 is any device capable of executing executable instructions. Processor 16 may comprise one or more of a microprocessor, micro controller, digital signal processor, co-processor, distributed processing circuitry, application specific integrated circuits or any suitable processing device known in the art or combinations thereof. Processor 16 is in communication with storage 12 and memory 42. Storage 12 and memory 42 are shown, in this example, as separate elements in FIG. 1, however, these elements may be included in a single memory device. Storage 12 and memory 42 can each be any suitable device capable of storing information such as but not limited to volatile and/or non-volatile storage devices such as random access memory (RAM), read only memory (ROM), hard drive, optical disc drive, floppy disc drive, etc. Memory devices, such as these examples and others, are well-known to those of ordinary skill in the art. In one example, the formatting methods and tools described herein are implemented as a combination of executable instructions and data stored in memory 42. Document 20, while shown separate from computing system 44 for illustration purposes in FIG. 1, can be stored in a storage device as described above such as storage 12.

Computing system 44 further includes, as seen in FIG. 1, application or applications 22. Application 22 is any tool capable of manipulating (i.e., creating, editing, storing, etc.) a document. Non-limiting examples of application 22 are Microsoft Word®, Excel®, and PowerPoint®. Memory 42, in this example, includes controller 30, reformatting module 32, format extraction module 34, and candidate identification module 36, each of which may be implemented as instructions executed by processor 16. Controller 30 can be any suitable component that is able to interface with a document 20 and/or application 22. For example, such an interface may be implemented via an application programming interface (API) wherein the modules of the formatting tool 40 are able to operate through an application such as Microsoft Word®. In other embodiments, however, controller 30 may operate directly on document 20 via computing system 44. Reformatting module 32, format extraction module 34, and candidate identification module 36 are shown as separate modules in FIG. 1 but can be combined with one another. Additionally, the functionality of reformatting module 32, formatting extraction module 34, and candidate identification module 36, as described further below, can be implemented independently of each other or combined as depicted in FIG. 1. Each module, individually, contains functionality and features that provide at least one advantage over the prior art as will be described.

Additionally shown in FIG. 1, coupled to computing system 44 are user input device 18 and display 14. User input device 18 is any device capable of providing input data from a user of formatting system 10. Non-limiting examples of user input device 18 are keyboards, mice, touch screens, trackballs, touchpads, and the like. Display 14 is any device capable of providing data to a user. Examples of display 14, include but are not limited to, flat screens, computer monitors, or other display mechanisms known to those of ordinary skill in the art. The connection shown in FIG. 1 between user input device 18 and display 14 and computing system 44 may be direct communication links. However, wireless or indirect connections such as connections via local or wide area networks, cellular networks, Bluetooth connections, or the like are equally contemplated between these components or other components of formatting system 10 already discussed.

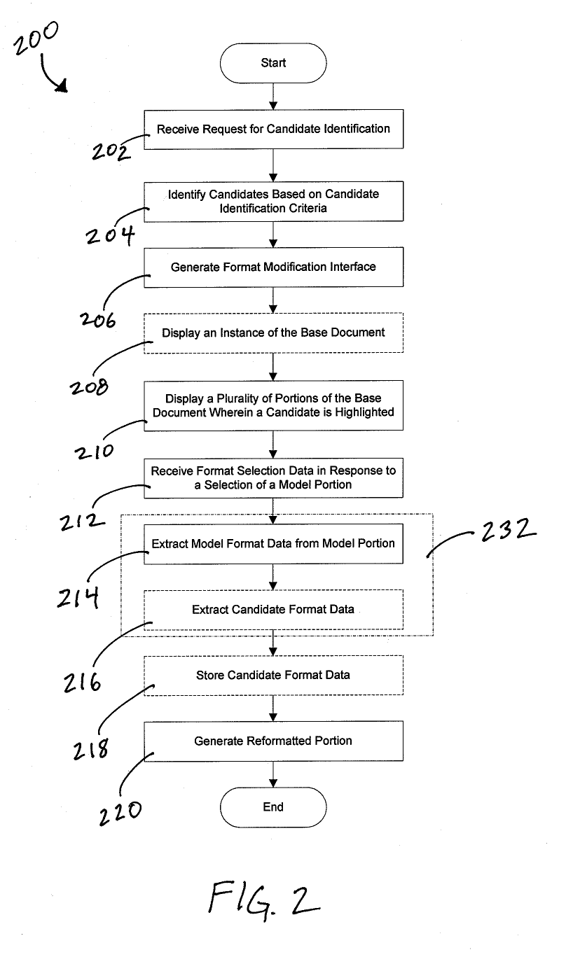

Now turning to FIG. 2, the flowchart illustrates one example of reformatting process 200. The steps depicted in FIG. 2 are for illustration purposes only and are not intended to indicate that all the shown steps need to be completed or that any combination of the steps shown need to be completed in combination unless specifically stated herein. The steps of FIG. 2, in one example, can be implemented as executable instructions provided on memory 42. The executable instructions are performed by processor 16 of computing system 44 to result in the reformatting process as will be described. FIG. 1 displays one embodiment of a sample organization of the executable instructions on memory 42. The executable instructions can be separated into candidate identification module 36, formatting extraction module 34 and reformatting module 32. In this embodiment, the process of the identification of candidates as will be further described with respect to step 204 of FIG. 2 is associated with the instructions of candidate identification module 36. The extraction of format data from a model portion and a candidate, as will be described with respect to steps 214 and 216 of FIG. 2, is associated with the instructions of formatting extraction module 34 and the remaining steps are associated with the instructions of reformatting module 32. This sample organization is but one example of the implementation of formatting tool 40. Other organizations or implementations of the formatting tool 40 as known to one of ordinary skill in the art can also be used.

As shown in FIG. 2, reformatting process 200 begins with step 202 wherein a request for candidate identification is received by the controller 30. The request can be any type of data that indicates that a user or other entity desires to identify portions of a document for reformatting. As used herein, the document that is being considered for reformatting is called a base document. In one example, the request can be received in response to the selection of a button within Microsoft Word® (included in the so-called ribbon) or other user input known to one of ordinary skill in art such as but not limited to a command line, keystroke, pull down menu, icon selection or the like may also be used. In response to an input via a user input device 18, formatting system 40 receives a request for candidate identification of the base document.

The next step is step 204 in which candidates are identified based on candidate identification criteria. A candidate is a portion of the base document that has been assessed as potentially requiring reformatting. In this step, the base document is analyzed to determine which portions, if any, meet certain requirements as represented by candidate identification criteria. A portion is a piece of a document that is separated from other pieces of the document by some type of formatting. For example, a portion can be a paragraph, a title, a bulleted entry, a numbered entry, a table, an image, or other piece of a document. These pieces of a document can be separated by paragraph indicators, hard returns, empty lines, different formatting patterns or other separators known to those of ordinary skill in the art. These separators that divide the pieces of a document into portions can in turn be used as candidate identification criteria. Candidate identification criteria can be any characteristic that is used to select a portion of a document for reformatting. Information that can be used as candidate identification criteria and during the candidate identification process is content data and format data. Content data can be used, for example, by analyzing a number or other initial characters used in a portion of a document. Certain characters such as numbers or single letters (i.e., a., b., c.) can suggest that a document is intended to contain a sequential list that could benefit from reformatting. Format data can also be used as a candidate identification criteria and/or during candidate identification. For example, portions of a document with a default style such as Normal can be used as candidate identification criteria. Format data such as the identification of rogue style data can also be used as candidate identification criteria. A rogue style is a style that has been introduced from an external document such as when a user pastes a portion into a document from an external document. These examples, as well as other types of format data can be used to identify candidates at step 204.

Format data includes many types of information. Format data can be information such as direct format data, traditional style data and document-specific format data. Direct format data, as opposed to traditional style data, is format data that is applied directly to a given text range instance. Direct format data information applies only to the range of text for which it is targeted. Traditional style data is format data applied to entire sections of a document. Traditional style data is declared once at the document level and then can be applied via reference to a portion of the document. An example of direct format data is the data associated with the underlining of a single word in a section of a document whereas traditional style data is the data associated with the underlining of all the text in a title section of a document. Document-specific format data is data relating to the format of a document that is not traditional style data. Document-specific format data may be formatting created by a method other than with the styles functionality of an application such as Microsoft Word®. An example of document-specific format data is data relating to the shape of a paragraph in a document that is created using tabs or margins applied to a portion of the document rather than applied using a traditional styles type of functionality.

With these types of data in mind, any one of these or a combination of different content data and format data can be used as candidate identification criteria during candidate identification. For example, candidate identification criteria could be whether a portion of a document includes a number in its first few words and if a first line of the portion is indented. At step 204, with this example candidate identification criteria, each portion of the base document would be analyzed to determine if the portion included a number in the first few words and if the first line of the portion was indented. If these sample candidate identification criteria are met, the identified portion of the document is tagged as a candidate for reformatting. The portion can be tagged by any method known to one of ordinary skill in the art. Other non-limiting examples of candidate identification selection criteria that may be used include determining if a portion of a document differs from surrounding portions of the document, whether a portion of a document includes excessive direct formatting, or whether a portion of a document has a traditional style applied other than a default or Normal style. Whether a portion has excessive direct formatting can be determined such as by determining if multiple portions of a document have the same direct formatting or by determining if a percentage of the text to which direct formatting is applied in a given portion exceeds a pre-defined threshold (e.g., 50%). Other methods known to one of ordinary skill in the art may also be applied Furthermore, multiple instances of candidate identification criteria can be employed, i.e., more than one type of candidate can be identified.

The candidate identification criteria, in one example, are set by an administrator and not accessible to other users. The candidate identification criteria, in another example, can be changed or modified according to individual users' preferences or in accordance with a particular need in a specific situation. Various methods and interfaces can be used for the modification of candidate identification criteria such as but not limited to pull-down menus, text boxes, slider-bars, radio buttons, and other user input interfaces known to those of ordinary skill in the art.

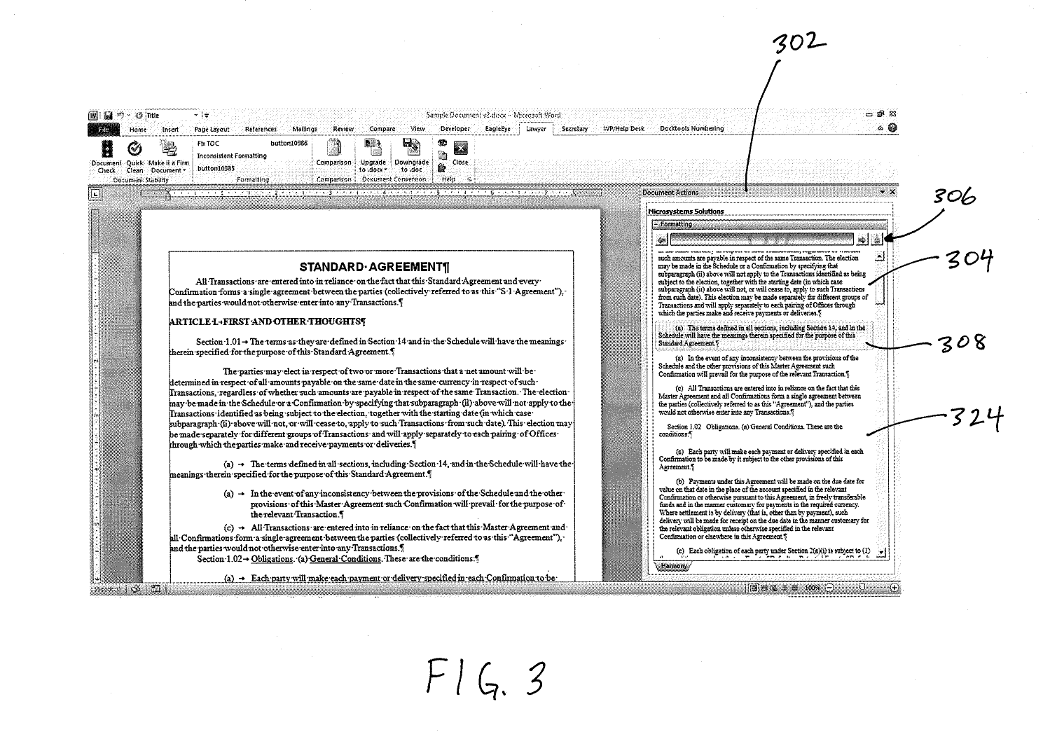

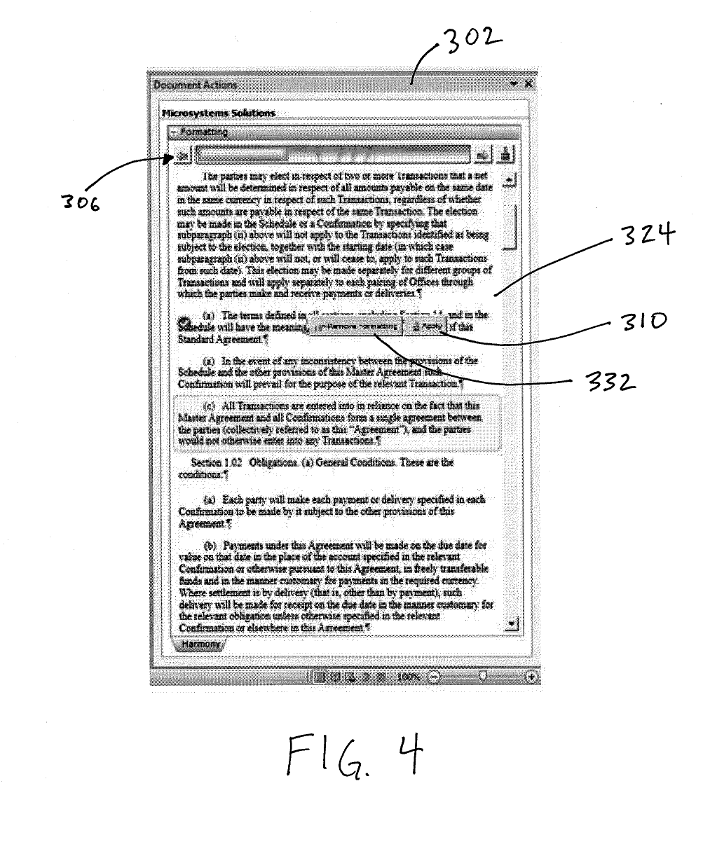

Referring back to FIG. 2, processing continues at step 206 in which the format modification interface is generated. Format modification interface 206 is any tool that allows or facilitates the reformatting of candidates of a document. FIG. 3 is one example of an interface that can be generated. Format modification interface 302, as shown, is generated in conjunction with the word processing application Microsoft Word®. Format modification interface, however, can stand alone as shown in FIG. 4. Format modification interface 302 can be a window or any user interface known to one of ordinary skill in the art.

As shown on FIG. 4, Format modification interface 302 includes list pane 324, candidate identification controls 306 and model portion selection control 310. These elements enable or facilitate the reformatting process via interaction with the candidates identified at step 204. List pane 324, for example, is a location on format user interface 302 in which a list of portions of the base document can be displayed. In this example, the actual text of portions of the base document are reproduced in list pane 324. Model portion selection control 310 allows the selection of a portion of the base document that a user would like to use as the basis for the reformatting of a candidate. As shown in FIG. 4, model portion selection control is a button labeled “Apply” but other types of controls known to one of ordinary skill in the art can be used. Some other non-limiting examples of controls include keystrokes, command lines, and mouse movements. The functionality of format modification interface 302 and its included elements will be described in more detail below as the steps of the process are further described.

Processing continues with step 208 in which an instance of the base document is displayed. As shown in FIG. 3, in one example, the base document is shown in its native application, here Microsoft Word®. The native application of the base document is only one example of how the instance of the base document can be displayed. User modification interface 302 could also include a base document pane in which an instance of the document is shown. Additionally, a separate preview window, or an image or a snapshot of the base document could displayed. Regardless of the specific embodiment of the display of the base document, the instance of the base document provides the user with a representation of the base document such that the reformatting and the location of portions of the base document can be referenced during the reformatting process. Step 208, as shown in FIG. 2 by the dotted lines, is not performed in some embodiments of the reformatting process. For example, in one embodiment, user modification interface 302 is a stand-alone interface, as shown in FIG. 4. In this embodiment, an instance of the base document is not displayed. In embodiments where the base document is not displayed processing continues as described below.

The next step is step 210 in which a plurality of portions of the base document are displayed wherein a candidate is highlighted. An example of this step is shown in FIG. 3. As shown, in list pane 324 of format modification interface 302, the portions of a base document are displayed. Among the portions of the base documents displayed, highlighted candidate 308 is displayed. Highlighted candidate 308 is one of the candidates identified from among the portions of the document displayed at step 204. Highlighted candidate 308 is highlighted, in this example, by a box of color differentiating the portion from the surrounding portions. Any type of highlighting can be used such that the candidate is identifiable as compared to the other portions included in list pane 324. Some other examples of highlighting include a different font or a different font color, underlining, a pointer, an identifying icon or any other identifying characteristic known to one of ordinary skill in the art.

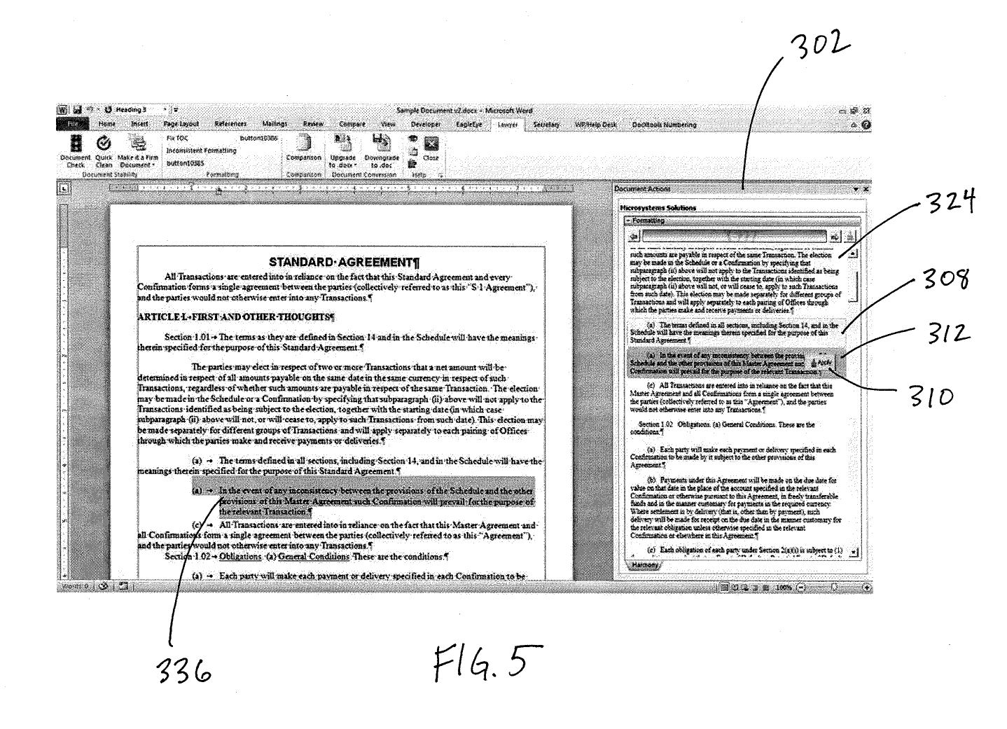

Formatting tool 40, via controller 30, then receives format selection data in response to a selection of a model portion at step 212. A model portion is a portion of the base document upon which the reformatting of a candidate will be based. At this step, in one example, a user chooses a model portion from among the portions shown on list pane 324 of user interface 302. The user chooses a model portion that includes formatting that the user would like to apply to the highlighted candidate displayed at step 210. After choosing the model portion, a user can select the model portion by clicking the “Apply” button of model portion selection control 310 shown in FIG. 5. Upon clicking the “Apply” button, formatting tool 40 receives format selection data. Format selection data can be any information that communicates to the formatting tool 40 that a model portion has been selected. The selection interface, in this example, as shown by the “Apply” button in model portion selection control 310 is one way that this process is performed. Additionally, different model portion selection controls can be used such as command lines, key strokes, or other methods and interfaces known to one of ordinary skill in the art.

At step 214, extraction process 232 begins. Extraction process 232 includes steps 214 and 216 and generally includes the extraction of format data from portions of the base document. At step 214, format data is extracted from the model portion. Format data is extracted from the selected model portion in response to the format selection data received at step 212. Additionally, format data can be extracted from a candidate of the base document in step 216. Whether the format data is extracted from the model portion or from the candidate, the format data is extracted using any suitable technique. In one embodiment, format data is extracted through interaction of controller 30 with application 22 via an application programming interface (API) such that the extensible markup language (XML) of the base document is accessed, searched and copied. Other methods known to those of ordinary skill in the art, however, may be used.

Processing continues at step 218 wherein the candidate format data is stored. The candidate format data can be stored using any suitable technique such as, but not limited to, saving the candidate format data to storage 12 of computing system 44. Candidate format data is stored at step 218 so that it can later be accessed and used if the reformatting of a candidate needs to reversed for example, where a user wants to restore a reformatted candidate portion of the base document to its original formatting. As seen by the dotted line indication of FIG. 2, steps 214 and 216 need not be performed in every embodiment of formatting tool 40. If the functionality that allows a user to restore the original formatting is not needed or desired, one example process does not include the extraction and saving of candidate format data.

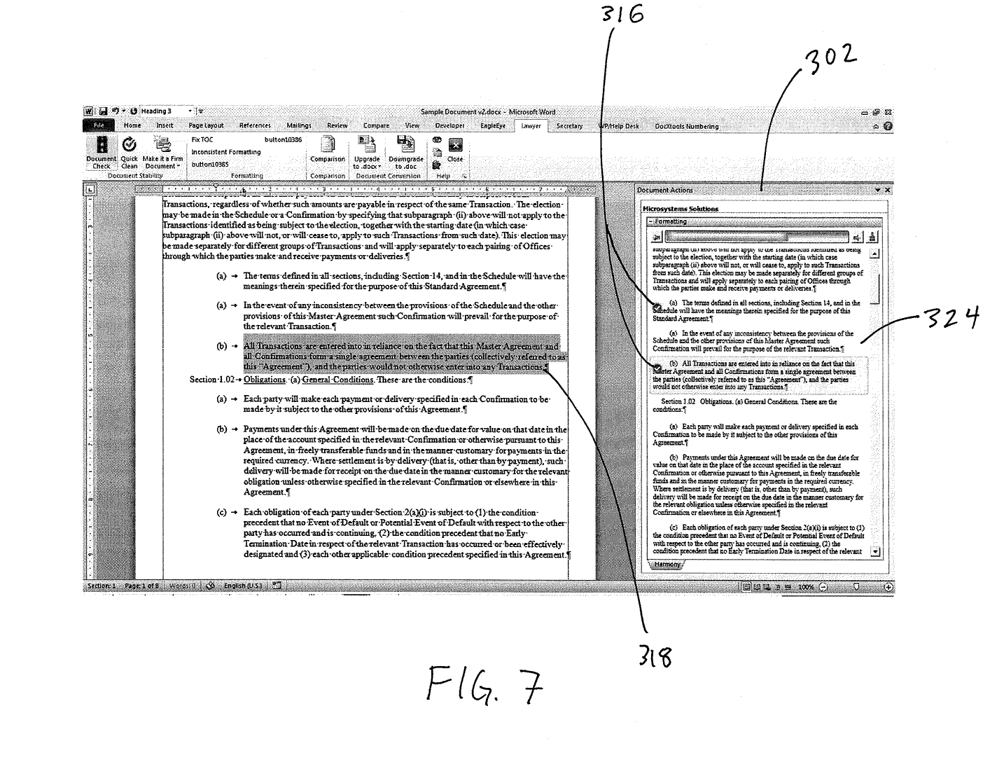

Processing continues to step 220 wherein the reformatted portion is generated. To begin the generation of the reformatted portion, the candidate is cleaned of data that may interfere with the reformatting. Content data such as numbers or other characters denoting or numbering a paragraph can be removed. Other data, such as but not limited to, spaces or blank lines can be removed. After this type of data (included as part of the candidate format data noted above) is removed, the format data extracted from the model portion at step 214 is applied to the candidate. One method of accomplishing this step is through the application of style format data from the model portion against the content data of the candidate. Next, any direct formatting that was extracted from the model portion at step 214 can be applied to the candidate. As a result of this processing or similar processing known to one of ordinary skill in the art, a reformatted portion is generated. The reformatted portion can additionally be displayed in user modification interface 302. As shown in FIG. 7, the portions indicated by reformat indicators 316 are displayed reformatted portions.

At this point, the reformat of one candidate from among the identified candidates has been performed. If multiple candidates were identified at step 204, steps 210 through 220 can be repeated. By repeating steps 210 through 220, further identified candidates can be highlighted in the user format interface 302. A model portion, the same as or different from the model portion selected when reformatting the initial candidate, is selected; format selection data is received; format data is extracted; and a second reformatted portion is generated. This can be repeated until all the identified candidates have been reformatted and displayed. Not all candidates, however, have to be reformatted. The format modification interface, as will be described, allows a user to navigate and control the display, selection, and reformatting of candidates as well as the display and selection of model portions.

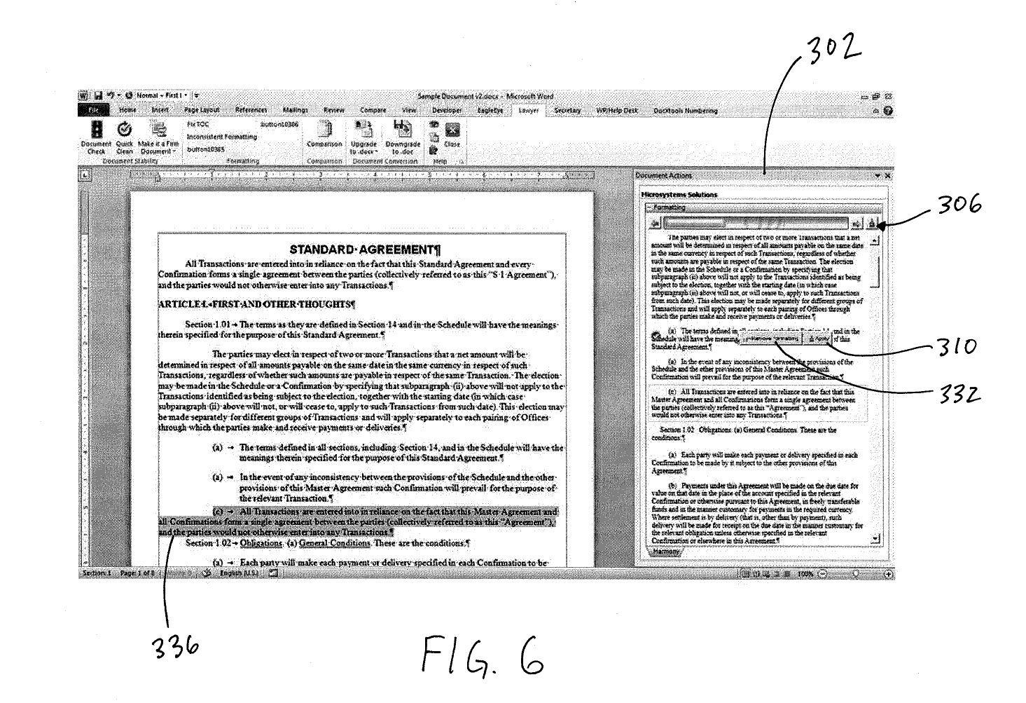

As shown in FIGS. 3 through 7, multiple examples of format modification interface 302 are shown at various stages of the reformatting process of the present disclosure. As discussed above, some steps of FIG. 2 may be repeated if more than one candidate is identified at step 204. Format modification interface 302, in one example, may include candidate identification controls 306. As shown in FIG. 3, in this example, candidate identification controls 306 includes a right-facing arrow button, a left-facing arrow button, and a status bar. These controls allow a user to navigate between identified candidates. For example, if multiple candidates are identified at step 204, format modification interface may initially include a highlighted candidate 308 as shown in FIG. 3. At this point, a user may choose to reformat the candidate via the processing previously described. Alternatively, a user may choose not to reformat the candidate and wants to move to the next identified candidate. This example format user interface allows the user to click on the right-facing button to move to the next identified candidate. After receiving data that a user has clicked the right-facing button, formatting tool 40 will highlight the next candidate from among the identified candidates and processing can continue with step 208. Conversely, after receiving data reflecting that a user has clicked the left-facing arrow, formatting tool 40 will move to the previous candidate and highlight the previous candidate in format modification interface 302. The status bar of format modification interface 302 displays the progress of the reformatting tool through the identified candidates. As the number of candidates reformatted increases, the bar displayed in the status bar reduces in length showing the progression of the reformatting process. FIG. 6 shows an example of a user modification interface 302 in which the status bar in candidate identification controls 306 shows that the reformatting progress has begun but additional identified candidates remain. The embodiments of the format modification interface 302 and candidate identification controls 306 discussed above can be provided in other embodiment using different techniques, interfaces, and controls known to one of ordinary skill in the art.

As briefly described in the explanation of step 218 above, formatting tool 40 may provide the step of storing candidate format data that is extracted from a candidate. Candidate format data may be stored so that a reformatted portion can be restored to its original formatting. One example of format modification interface 302 includes the facilitation of this function through a remove formatting control 332 as shown on FIG. 4 and FIG. 6. As shown, in this example, a button is provided in format modification interface 302. The remove formatting control 332 provides data to formatting tool 40, typically via user input device 18 and controller 30, that, when received by formatting tool 40, restores the reformatted portion to its original formatting. The remove formatting control 332, in essence, is an “undo” functionality. Unlike traditional “undo” functions as known to those of ordinary skill in the art, however, the remove formatting control 332 allows a user to restore the original formatting at any point in the process and is not limited to restoring only the most recently reformatted portion to its original state. The restoration processing that occurs in response to a user's selection of the remove formatting control 332 is similar to the reformatting process discussed with respect to step 220 except that the stored candidate format data is applied to the portion rather than the extracted model format data. Since the candidate format data is stored, such as in storage 12 of computing system 44, a reformatted portion can be restored at any time during or after the reformatting process. Remove formatting control 332 is shown as a button in format modification interface 302 but other control, as known to one of ordinary skill in the art, can be used such as text boxes, pull-down menus, keystrokes, command lines and the like.

User format interface includes other features and functionality that can provide advantages in the reformatting of portions of a document. In one example, user format interface 302 includes a list 304 of portions of a base document. List 304 can be a reproduction of the text of the portions of the base document in list pane 324 as shown in FIG. 3. List 304 can be implemented via other methods as well such as displaying a few words of each portion of the base document, displaying numbers or icons representing portions of a document, or any other method known to one of ordinary skill in the art such that candidates and model portions can be highlighted and selected.

The highlight, identification, and selection of portions of a base document can include other features and controls. As discussed earlier, format modification interface 302 can be implemented separate from or with the inclusion of an instance of the base document. One example is shown in FIG. 3 wherein modification user interface 302 opens within an application such as Microsoft Word. In this example, the instance of the base document is actually a document that is active (i.e. open in the native application). In an embodiment, when portions of the base document are highlighted, selected, or otherwise interacted with in the format modification interface 302, corresponding indications are shown on the instance of the base document. For example, as shown in FIG. 5, a highlighted model portion 312 is displayed in list pane 324. The same portion, but displayed in the instance of the base document in a word processing application, is displayed as a highlighted base document portion 336. Additionally, as shown in FIG. 7, as a candidate is reformatted to generate a reformatted portion, the reformatted portion is highlighted in the instance of the base document to display a highlighted reformatted portion 318

Additional graphical or other indicators can be provided by formatting tool 40. One example is a reformat indicator 316 as shown in FIG. 7. Reformat indicator 316 is displayed in list pane 324 of format modification interface 302 in conjunction with a displayed portion. After a candidate is reformatted, as by step 220 for example, reformat indicator 316 is displayed next to the reformatted portion to indicate a reformat of that portion has been performed. Reformat indicator is shown as a graphical icon but other indicators, as known to one of ordinary skill in the art, such as highlighting, text color, font size or font type may be equally used.

The above description of the present disclosure should not be interpreted such that the steps of the process discussed above are required to be performed in the order discussed unless specifically stated. The steps discussed above should also not be interpreted as required or as a whole to provide the advantages of the present disclosure. The above description and the examples described herein have been presented for the purposes of illustration and description only and not by way of limitation. It is therefore contemplated that the present disclosure cover any and all modification, variation or equivalents that fall within the spirit and scope of the basic underlying principles disclosed above and claimed herein.

1. A method for reformatting a base document comprising:
identifying at least one candidate for reformatting based on candidate identification criteria;
displaying a plurality of portions of the base document wherein a candidate of the at least one candidate is highlighted to provide a selected candidate;
receiving format selection data indicating a selection of a model portion from among the plurality of portions; and
generating a reformatted portion based on model format data of the model portion and candidate content data of the selected candidate.

2. The method of claim 1 further comprising displaying the base document and the plurality of portions wherein that portion of the base document corresponding to the candidate is highlighted when the candidate is highlighted.

3. The method of claim 1 further comprising extracting the model format data from the selected model portion.

4. The method of claim 1 further comprising removing candidate format data from the candidate.

5. The method of claim 1 further comprising extracting and storing candidate format data from the candidate such that original formatting of the candidate can be restored.

6. A method for facilitating the reformatting of portions of a base document comprising:
identifying at least one candidate for reformatting based on candidate identification criteria;
generating a format modification interface comprising:
a list displaying a plurality of portions of the base document;
a candidate identification control operable to control which candidate of the at least one candidate is highlighted to provide a selected candidate;
a model portion selection control operable to identify a model portion from among the plurality of portions; and
generating a reformatted portion based on model format data of the model portion and candidate content data of the selected candidate.

7. The method of claim 6, wherein the model portion selection control is further operable to identify a portion in an instance of the base document that corresponds to the model portion.

8. The method of claim 6, wherein the format modification interface further comprises a remove formatting control operable to restore original formatting of the reformatted portion.

9. An apparatus for reformatting a base document comprising:
at least one processing device; and
memory operatively connected to the at least one processing device, the memory comprising executable instructions that when executed by the at least one processing device cause the at least one processing device to:
identify at least one candidate for reformatting based on candidate identification criteria;
display a plurality of portions of the base document wherein a candidate of the at least one candidate is highlighted to provide a selected candidate;
receive format selection data indicating a selection of a model portion from among the plurality of portions; and
generating a reformatted portion based on model format data of the model portion and candidate content data of the selected candidate.

10. The apparatus of claim 9, wherein the executable instructions, when executed by the at least one processing device, cause the at least one processing device to display the base document and the plurality of portions wherein that portion of the base document corresponding to the candidate is highlighted when the candidate is highlighted.

11. The apparatus of claim 9, wherein the executable instructions, when executed by the at least one processing device, cause the at least one processing device to extract the model format data from the selected model portion.

12. The apparatus of claim 9, wherein the executable instructions, when executed by the at least one processing device, cause the at least one processing device to remove candidate format data from the candidate.

13. The apparatus of claim 9, wherein the executable instructions, when executed by the at least one processing device, cause the at least one processing device to extract and store candidate format data from the candidate such that original formatting of the candidate can be restored.

14. A non-transitory computer readable medium comprising executable instructions that when executed by at least one processing device cause the at least one processing device to:
identify at least one candidate for reformatting based on candidate identification criteria;
display a plurality of portions of the base document wherein a candidate of the at least one candidate is highlighted to provide a selected candidate;
receive format selection data indicating a selection of a model portion from among the plurality of portions; and
generating a reformatted portion based on model format data of the model portion and candidate content data of the selected candidate.

15. The non-transitory computer readable medium of claim 14, wherein the executable instructions, when executed by the at least one processing device, cause the at least one processing device to display the base document and the plurality of portions wherein that portion of the base document corresponding to the candidate is highlighted when the candidate is highlighted.

16. The non-transitory computer readable medium of claim 14, wherein the executable instructions, when executed by the at least one processing device, cause the at least one processing device to extract the model format data from the selected model portion.

17. The non-transitory computer readable medium of claim 14, wherein the executable instructions, when executed by the at least one processing device, cause the at least one processing device to remove candidate format data from the candidate.

18. The apparatus of claim 14, wherein the executable instructions, when executed by the at least one processing device, cause the at least one processing device to extract and store candidate format data from the candidate such that original formatting of the candidate can be restored.
